(19) United States
(12) Patent Application Publication
(10) Pub. No.: US 2006/0161810 A1
(43) Pub. Date: Jul. 20, 2006

(54) Remote replication

(76) Inventor: Bill Q. Bao, Camarillo, CA (US)

Correspondence Address: Phil Virga, 1525 Aviation Blve., #105, Redondo Beach, CA, 90278, US

(21) Appl. No.: 11/212,194

(22) Filed: Aug. 25, 2005

Related U.S. Application Data
(60) Provisional application No. 60/604,359, filed on Aug. 25, 2004.
(60) Provisional application No. 60/604,195, filed on Aug. 25, 2004.

(51) Int. Cl. G06F 11/00

(52) U.S. Cl. 714/6

(57) ABSTRACT

A remote replication system for reading data, without server involvement, from any industry standard Fibre Channel LUN and producing an exact copy on a specified virtual volume is provided. The remote replication system further produces remote mirrored copies of virtual volumes on another storage platform and remote mirrored copies of virtual volumes on 3rd party Fibre Channel arrays. Additionally, the remote replication system acquires and migrates data from external Fibre Channel volumes, producing a virtual volume mirror and n-way copies.

### CROSS-REFERENCE TO RELATED APPLICATIONS

This application claims priority to U.S. Provisional Application No. 60/604,359, filed on Aug. 25, 2004, entitled Remote Replication, the disclosure of which is hereby incorporated by reference in its entirety. Additionally, the entire disclosures of the present assignee's following U.S. Provisional Application No. 60/604,195, entitled Storage Virtualization, filed on the same date as the present application is incorporated herein by reference in its entirety.

### BACKGROUND

The present invention relates generally to techniques for storage replication, and in particular to techniques for remote storage replication.

Conventionally, there have been two types of approaches to storage-based replication, local and remote replication. Both technologies mirror files, file systems, or volumes without using host CPU power. When a host writes data to a volume containing production data, the storage system automatically copies the data to a replication volume. This mechanism ensures that data volume and replication volume are identical. The local replication approaches duplicate volumes within one storage system, so that the data volumes and replication volumes are in the same storage system. The local replication approaches are typically used for taking backups. When a user by manual means, or a back-up program, splits a mirrored pair, data written from a host is no longer copied to the replication volume. Accordingly, the replication volume now contains a backup of data volume. To restore the whole volume, the user can re-synchronize data volume with replication volume. To restore individual files, the user can copy files from replication volume to data volume through host.

The remote replication duplicates volumes across two or more storage systems. Data is transferred through paths, such as ESCON, Fibre Channel, T3, and/or IP networks, directly connecting two storage systems. The remote replication typically used to recover data from disasters, such as earthquake, flood, fire, and the like. Even if the storage system or the whole data center at the primary site is damaged by a disaster, data is still at the secondary site and businesses may be resumed quickly.

What is needed are improved techniques for managing storage based replication.

### SUMMARY

A remote replication system for reading data, without server involvement, from any industry standard Fibre Channel LUN and producing an exact copy on a specified virtual volume is provided. The remote replication system further produces remote mirrored copies of virtual volumes on another storage platform and remote mirrored copies of virtual volumes on 3rd party Fibre Channel arrays. Additionally, the remote replication system acquires and migrates data from external Fibre Channel volumes, producing a virtual volume mirror and n-way copies.

### BRIEF DESCRIPTION OF THE DRAWINGS

FIG. 1 is a schematic illustration of a storage virtualization system;

FIG. 2 is a schematic illustration of a virtual disk copy system;

FIG. 3 is a block diagram of the storage virtualization system;

FIG. 4 is a schematic illustration of multiple storage pools;

FIG. 5 is a diagram illustrating a layout of a storage area disk;

FIG. 6 is a schematic illustration of a virtual disk's volume access and usage bitmap;

FIG. 7 is a block diagram illustrating a virtual disk's storage allocation and address mapping;

FIG. 8 is a flowchart for Logical Unit number (LUN) mapping;

FIG. 9 is a flowchart for a procedure of storage allocation during creation of a virtual disk;

FIG. 10 is a block diagram illustrating an example of Local Unit number (LUN) mapping;

FIG. 11 is a flowchart for Local Unit number (LUN) masking (access control);

FIG. 12 is a schematic illustration of Logical Unit (LUN) number mapping and masking;

FIG. 13 is a table depicting operating system partition and file system interface;

FIG. 14 is a flowchart for a procedure of storage allocation when growing a virtual disk;

FIG. 15 is a schematic illustration of a remote replication system;

FIG. 16 is a flowchart for a procedure of remote replication;

FIG. 17 is a graphical representation of the bitmap usage layout in matrix form for remote replication; and

FIG. 18 is a graphical representation of the scoreboard usage layout in matrix form for remote replication.

### DETAILED DESCRIPTION

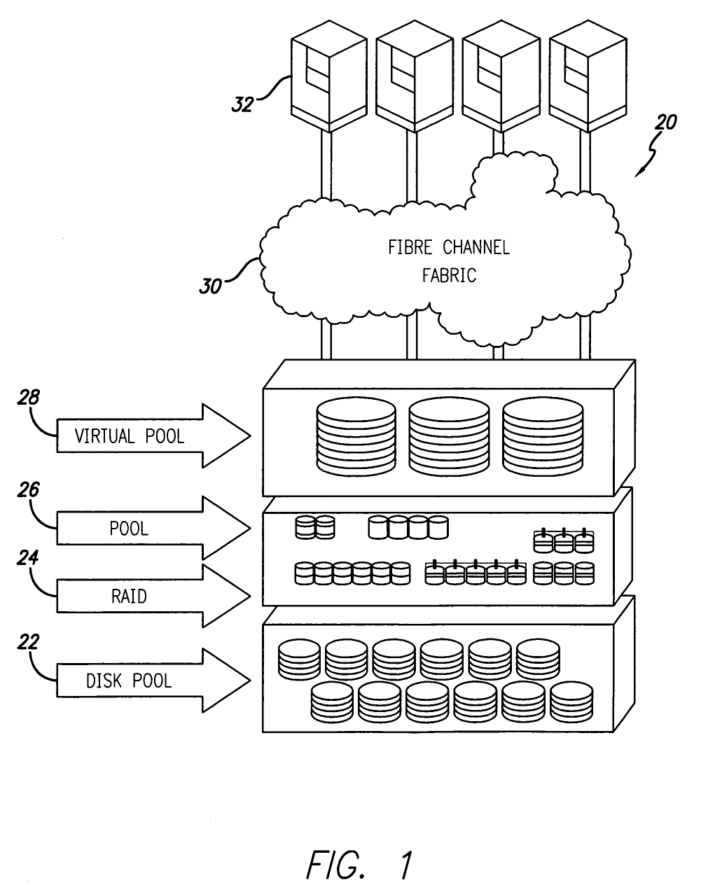

The key to realizing the benefits of networked storage and enabling users to effectively take advantage of their network storage resources and infrastructure is storage management software that includes virtualization capability. Referring to FIG. 1 there is shown a schematic illustration of a storage virtualization system 20 that follows a four-layer hierarchy model, which facilitates the ability to create storage policies to automate complex storage management issues. As shown in FIG. 1 the four-layers are a disk pool 22, Redundant Arrays of Independent Disks (RAID arrays) 24, storage pools 26 and a virtual pool of Virtual Disks (Vdisks) 28.

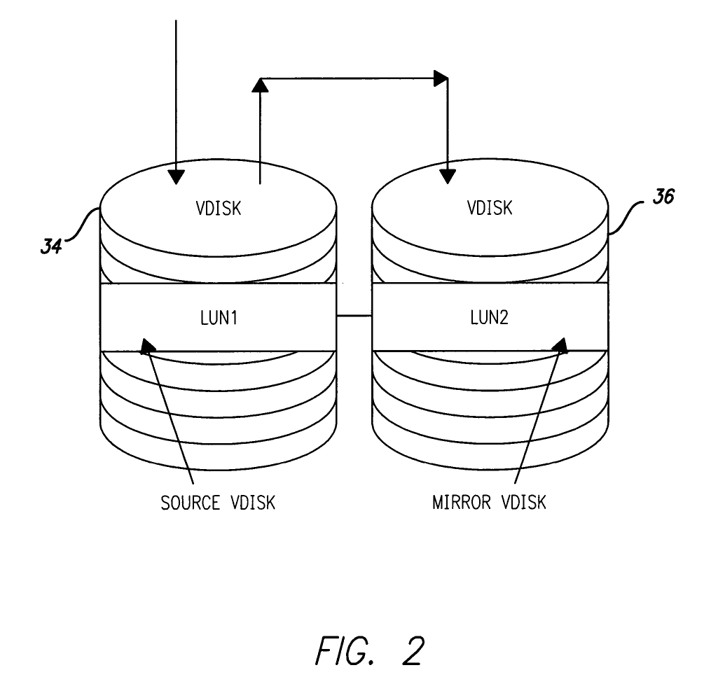

The storage virtualization system 20 allows any server or host 32 to see a large repository of available data through by example a fiber channel fabric 30 as though it was directly attached. It allows users to add storage and to dynamically manage storage resources as virtual storage pools instead of managing individual physical disks. The storage virtualization system 20 features enable virtual volumes to be created, expanded, deleted, moved or selectively presented regardless of the underlying storage subsystem. It simplifies storage provisioning thus reducing administrative overhead. Referring to FIG. 2 the storage virtualization system 20 enables IT professionals to easily expand or create a virtual disk on a per file system basis. If an attached server requires additional storage space, either an existing virtual disk 34 can be expanded, or an additional virtual disk 36 can be created and assigned to the server. The process of adding or expanding virtual disk volumes is non-disruptive with no system downtime.

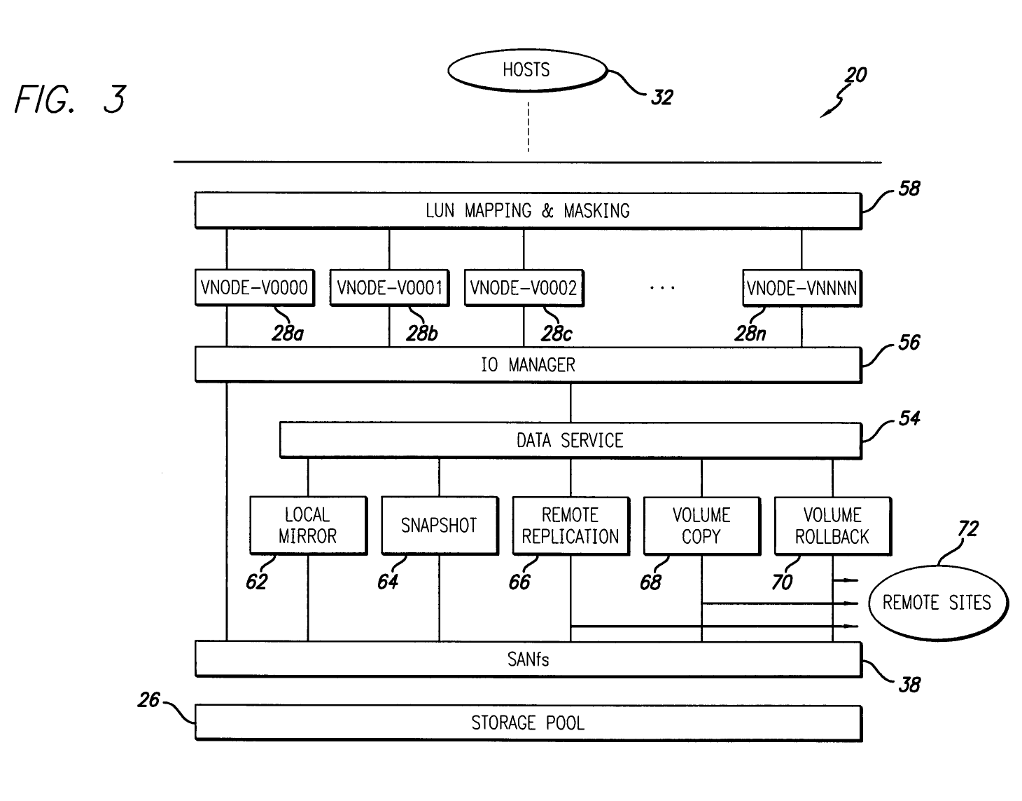

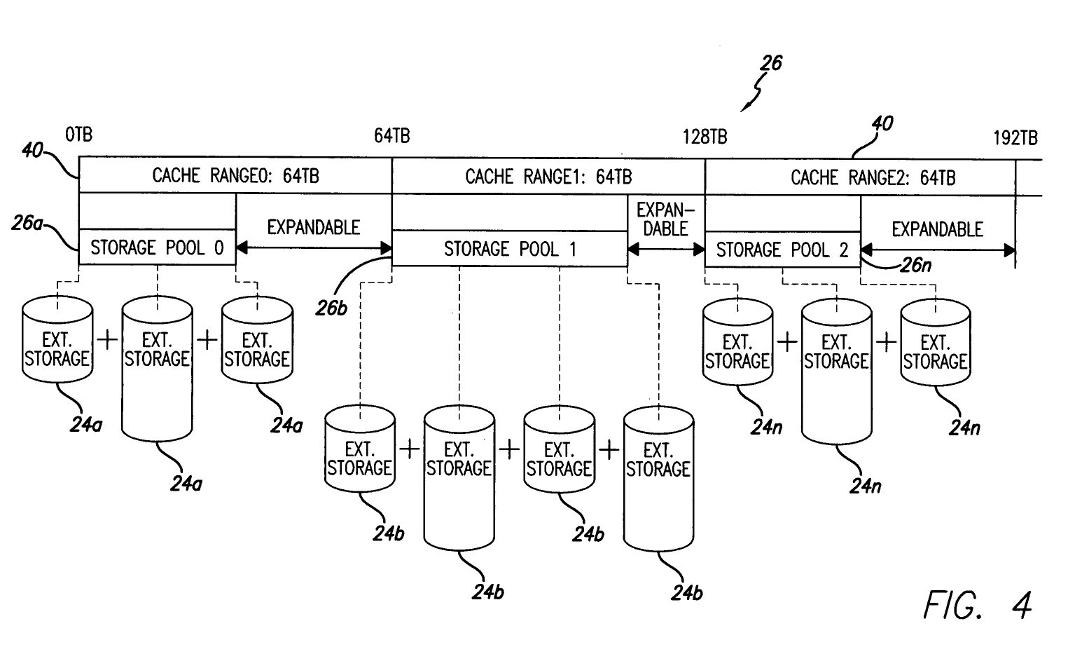

Turning now to FIG. 3 there is shown a block diagram of the storage virtualization system 20 wherein a volume manager or storage area network file system (hereinafter referred to as SANfs) 38 is the foundation of the storage virtualization system 20 and data service. SANfs 38 may be built onto any raw storage devices (eg, RAID storage or hard drive) to provide storage provisioning and advanced data management. The process of creating virtual storage volumes or a storage pool 26 begins with the creation of RAID arrays. These arrays may be formatted as RAID level 0, 1, 3, 4, 5, or 10 (0+1). Referring to FIG. 4 there is shown a schematic illustration of multiple storage pools 26a, 26b through 26n. A storage pool 26 is defined as a concatenation of RAID storage and/or other external storage unit's 24a, 24b through 24n. Each storage pool 26 shares a central cache 40, boosting the overall host I/O performance. There are 64 terabytes of cache address space allocated to each storage pool 26, thus each storage pool 26 can dynamically expand up to 64 terabytes. External Storage, such as a hard drive, RAID storage 24, or any 3rd party storage unit, may be added into a storage pool 26 for capacity expansion without interrupting on-going I/O.

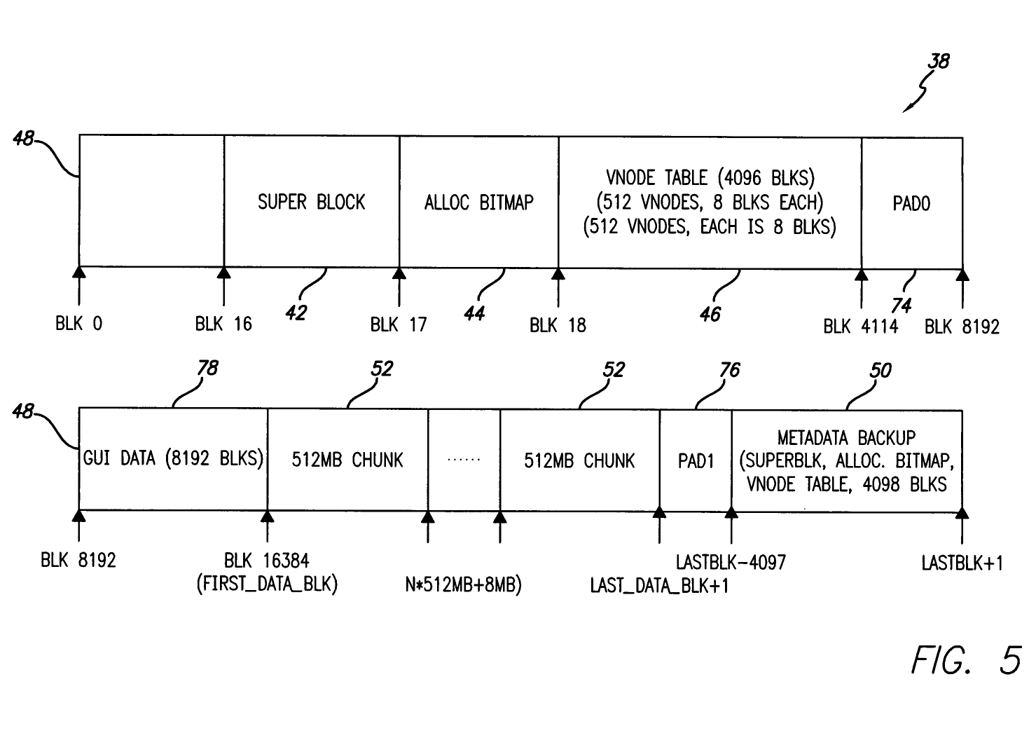

A diagram illustrating a layout of a SANfs 38 on a storage pool 26 is shown in FIG. 5. Each storage pool 26 has its own SANfs 48 created for virtualization and data service management 20. As shown in the diagram each SANfs 48 has a super block 42, an allocation bitmap 44, a vnode table 46, Pad0 74, GUI data 78, payload chunks 52 in predefined size of 512 MB or more and Pad1 76 ending in an application-defined metadata area 50. The super block 42 holds SANfs 48 parameters and layout map with its content loaded into memory for quick reference. Therefore the super block 42 contains file system parameters that are used to construct the sanfs layout and vnode table 46. Most of the parameters are set by the SANfs 38 creation utility based on external storage information. All number values in the super block and vnode are in little endian. The same operating code can handle multiple SANfs 38 with different parameters based on their super block 42 content. The allocation bitmap 44 records free and used chunks in a SANfs 48 wherein one bit represents one chunk. The chunk size is the minimum allocation size in a SANfs 48 with the chunk sizes itself a SANfs parameter. Therefore a SANfs with a chunk size of 512 MB may manage up to two (2) TB capacity (512*8*512 MB) and for a chunk size of two (2) GB, the SANfs 38 may manage up to eight (8) TB capacity (512*8*2 GB.) SANfs 48 may resize online by adjusting the allocation bitmap 44 and super block parameters 42 wherein each SANfs 38 may present up to 512 volumes.

The allocation bitmap 44 is always 512 bytes in size. The allocation bitmap 44 is used to monitor the amount of free space currently on a storage pool 26. The free space is monitored in chucks of 512 MB. The maximum number of chunks is 4096, with chunk size of 16 GB, it manages up to 64 TB storage. The bitmap 44 is constantly updated to reflect the space that has been allocated or freed on a storage pool. The vnode table 46 is used to record and manage virtual disks or volumes that have been created on a storage pool and is the central metadata repository for the volumes. There are 512 vnodes 28 in a vnode table 46 wherein each vnode is 4 KB in size (8 blocks), thus a vnode table is 512×4 KB in size (4096 blocks). The Pad0 74 locations is reserved for future use with pad1 76 and the sanfs metadata backup area 50 being used as data chunk during storage pool 26 expansions. The metadata backup area 50 is always stored at the end of a storage pool 26. A sanfs expansion utility program relocates the metadata backup 50 to the end, and re-calculates the size of pad1 76 and the last_data_blk 80. Lastly, the metadata backup area 50 is comprised of the super block 42, allocation bitmap 44, and the vnode table 46. Thus, two copies of the metadata are maintained, one at the beginning and one at the end of a storage pool 26. The metadata can be recovered if one copy is lost or corrupted.

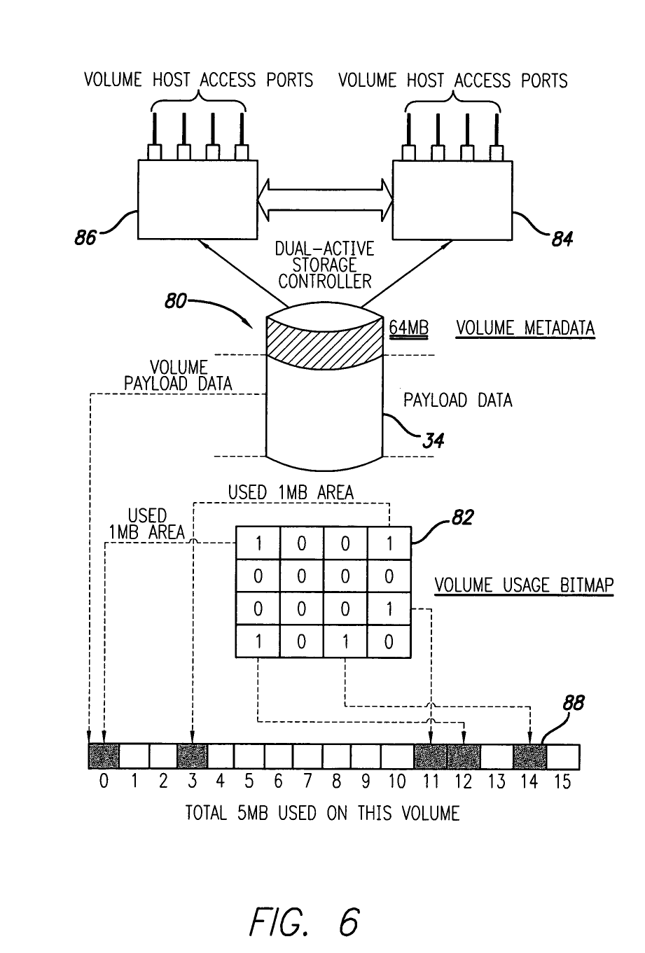

Referring to FIG. 6 there is shown a schematic illustrating a virtual disk volume access 80 and usage bitmap 82. A volume 34 is a logical storage container, which may span multiple SANfs chunks, continuously or discretely. Referring to FIG. 3, the servers or hosts 32 see the storage virtualization volumes as physical storage devices. A volume 34 may grow or shrink online, though the volume shrink is normally disabled. The volume structure and properties are described by Vnode 26 and stored in the SANfs 38 Vnode table area 46. Each volume 34 may be accessed on two controllers 84 and 86 at specified ports as a single image. This allows for I/O path redundancy. Turning to FIG. 6 each volume 34 has a reserved 64 MB area at the beginning to store volume specific metadata, such as the volume's usage bitmap 82. Each volume 34 has the usage bitmap 82 to record if an area in its payload data has ever been written. A volume's payload data is virtually partitioned into 1 MB chunks 88 numbered as chunk 0 . . . N−1. If there is a write to chunk m, then the bit m in the usage bitmap 82 will be set. The volume usage bitmap facilitates fast data copy during volume mirroring and replication, i.e., only used data chunks in the source volume need to be copied.

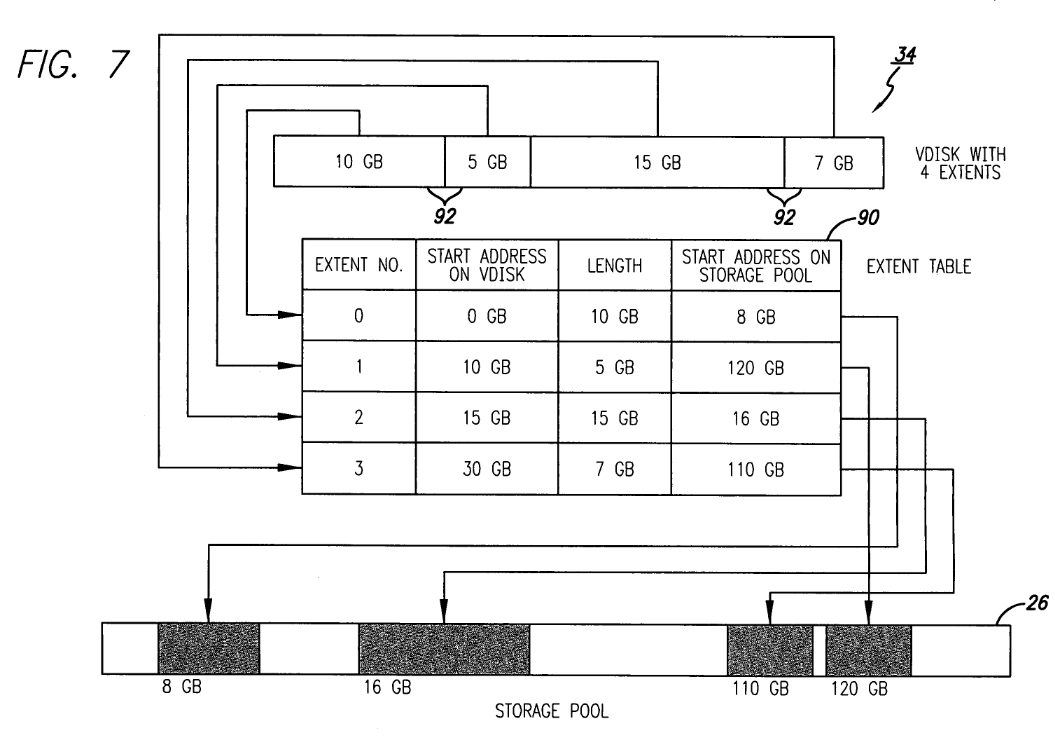

Referring to FIG. 7 there is shown a block diagram illustrating a virtual disk's storage allocation and address mapping. Volume storage allocation uses extent-based capacity management where an extent 92 is defined as a group of physically continuous chunks in a SANfs. Each vdisk 34 has an extent table 90 stored in its Vnode 28 to record volume storage allocation and direct vdisk 34 accesses to the storage pools 26 access. Vdisk storage allocation utilizes an extent-based capacity management scheme to obtain large continuous chunks for a vdisk and decrease SANfs fragment. A vdisk may have multiple extents. A Vnode 28 and its in-core structure have following functional components: volume properties, such as size, type, serial number, internal LUN, and host interfaces to define the volume presentation to host and the extent allocation table 90 to map logical block address to physical block address. A vdisk 34 may have multiple extents 92.

Referring once again to FIG. 3 the Host 32 IO requests and internal volume manipulation are handled by the IO manager 56 utilizing the storage virtualization system 20. The IO manager 56 initiates data movement based on the volume type and its associated data services. The volume type includes: normal volume, local mirror volume, snapshot volume and remote replication volume. The data services associated with a normal volume includes local mirror 62, snapshot 64, remote replication 66, volume copy 68 and volume rollback 70. For a Host 32 IO to a normal volume operation, the IO manager 56 translates the Host 32 IO logical address into the SANfs 38 physical address. As the SANfs 38 minimum extent size is 512 MB, most of the host IO will reside in one extent and the IO manager 56 only needs to initiate one physical IO to the extent 92. For the cross-extent host IO, the IO manager 56 will initiate two physical IOs to the two extents. Given the fact that most volumes have only one extent 92 and the cross-extent host IO is rare, the IO translation overhead is trivial. There is almost no performance penalty in the virtualization layer.

For a write to normal volume with local mirror 62 attached operations, the IO manger 56 will also copy the write data to the local mirror volume. As the copy happens inside the cache 40, for burst-write, the cost is just an extra memory move. For a write to normal volume with remote replication 66 attached operations, the IO manager 56 will also send the write data to the replication channels. In synchronized replication mode, the IO manager 56 will wait the write ACK from remote site before acknowledging the Host 32 the write completion, thus incurring larger latency. In asynchronized replication mode, the IO manager 56 will acknowledge host the write complication once the data has been written to the local volume, and schedule the actual replication process into background.

For a write to normal volume with snapshot 64 attached operations, the snapshot 64 uses the copy-on-write (COW) technique to instantly create snapshot with adaptive and automatic storage allocation. The initial COW storage allocated is about 5% to 10% of the source volume capacity. When COW data grows to exceed the current COW storage capacity, the IO manager 56 will automatically allocate more SANfs 38 chunks to the COW storage. For this kind of write, the IO manager 56 will first do the copy-on-write data movement if needed, then move the write data to the source volume. For Data movement during volume copy 68 operations, a volume copy operation is used to clone volume locally or to remote sites. Any type of volumes may be cloned. For example, by cloning a snapshot volume, a full set of point in time (PIT) data will be generated for testing or achieving purpose. During the volume clone process, the IO manager 56 reads from the source volume and writes to the destination volume. Lastly, for data movement during volume rollback 70 operations, when a source volume has snapshots, or suspended local mirror 62 or remote replication 66, a user may choose the volume rollback operation to bring back the source volume content to a previous state. During the rollback operation, the IO manager 56 selectively reads the data from the reference volume and patch to the source volume.

Referring back to FIG. 3, the Logical Unit numbering (LUN) mapping and masking 58 occurs just below the Host 32 level and offers volume presentation and access control. The storage virtualization system 20 may present up to 128 volumes per host port to the storage clients. Each volume is assigned an unique internal LUN number, called ilun (0 . . . 127), per host interface. The LUN mapping 58 allows a Host 32 to see a volume at the host designated LUN address (called hlun). A Host is identified by its HBA's WWN, called hWWN. The SANfs maintains the LUN mapping table per host port. FIG. 10 is a block diagram illustrating an example of Local Unit number (LUN) mapping illustrating a table 144 having three components and two keys. The three components are hWWN, hlun, ilun. KEYₕ is generated by hashing the related hWWN and hlun together. KEYᵢ is generated by hashing the related hWWN and ilun together.

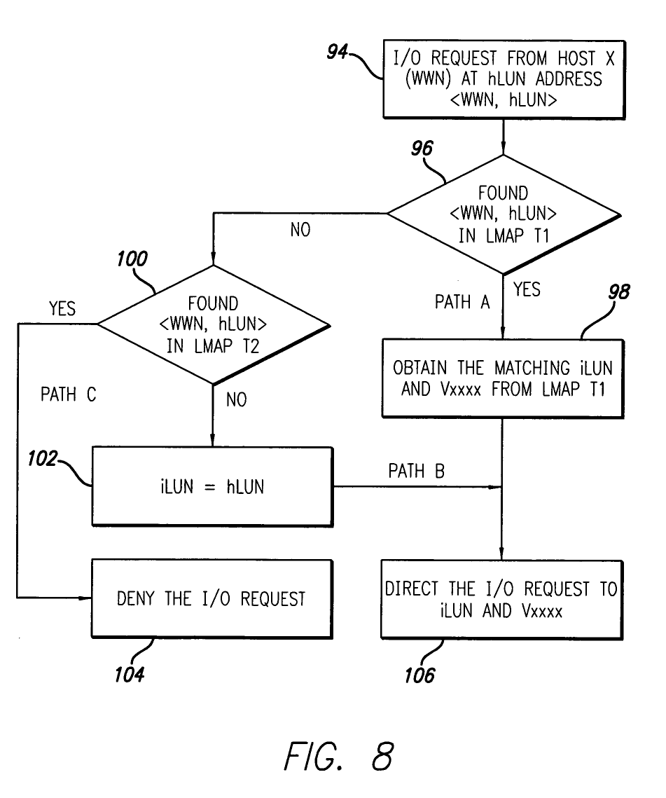

FIG. 8 is a flowchart for Logical Unit number (LUN) mapping 58 wherein when an request 94 comes in it always carries the hWWN and hlun to tell from which host this IO comes from and at what LUN address. The LUN mapping code calculates the key from the incoming hWWN and hlun by the same hash function, and looks up 96 the LUN mapping table in the following sequences:
1. If the key matches a KEYₕ in the table 144 (LMAP T1), direct the IO request to the volume whose internal LUN has the value of the associated ilun 98, otherwise go to 2.
2. If the key matches a KEYᵢ in the table 146 (LMAP T2), reject the IO request, otherwise go to 3.
3. Direct the IO request to the volume whose internal LUN equals to the hlun 102. This means there is no LUN mapping on the <hWWN, hlun>.

For example, with LUN mapping properly set up, Host A 162 can view volume 0 to volume 5 as LUN 0 to LUN 5, Host B 164 can view volume 6 to volume 10 also as LUN 0 to LUN 5 instead of as LUN 6 to LUN 10. LUN masking controls which hosts can see a volume 160. Each volume can store up to 64 host HBA WWNs, from which the accesses are allowed. When LUN masking is turned on, only those IO requests from the specified hosts will be honored. As shown in the flowchart of FIG. 8, path A is for normal LUN mapping access. Path C is to block access to a vdisk which has a LUN mapping address different from the hLUN 94 and path B is for access without LUN mapping 108.

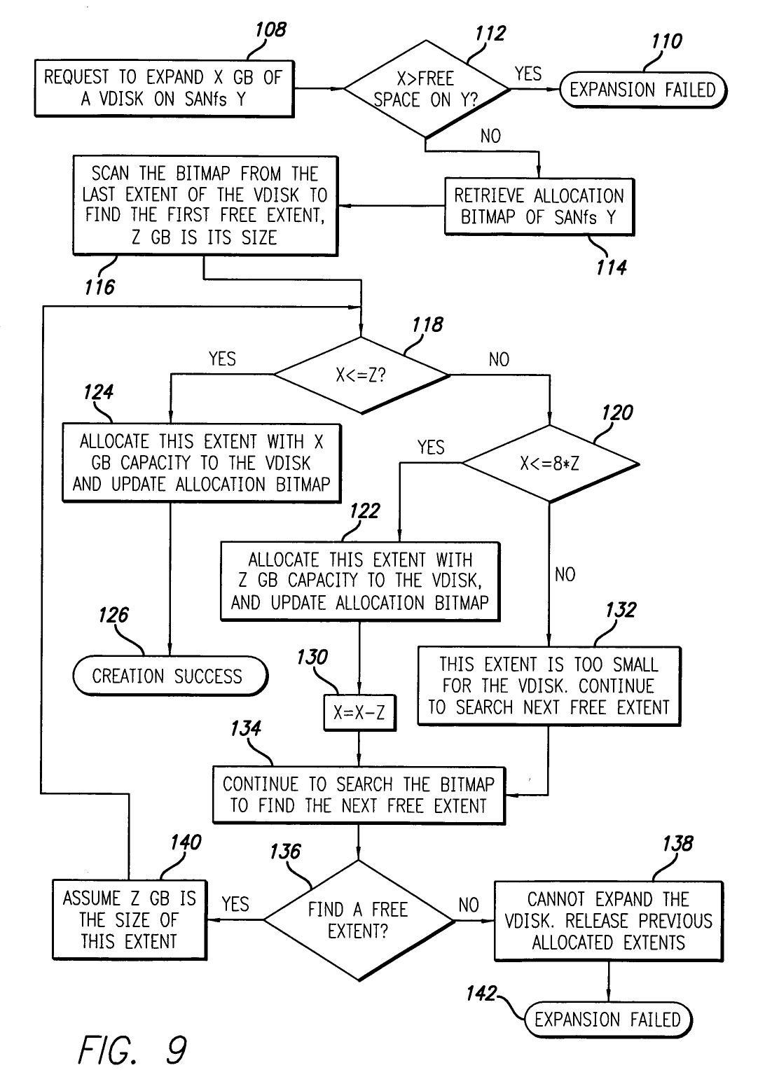

FIG. 9 is a flowchart for a procedure of storage allocation during creation of a virtual disk wherein a request to create a vdisk of X GB on SANfs Y 108. If X>free space on Y 112 then the creation failed 110. If not then retrieve the allocation bitmap of SANfs Y 114 and scan the bitmap from the beginning to find the first free extent, Z GB in size 116. If X<=Z 118 then allocate this extent with X GB capacity to the vdisk and update allocation bitmap 124 and the creation was a success 126. If X=>Z then check to see if X<=8*Z 120 and if yes allocate this extent with Z GB capacity to the vdisk, and update allocation bitmap 122. Perform the operation X=X−Z 130 and continue to search the bitmap to find the next free extent 134. If X=>8*Z then this extent is too small for the vdisk and continue to search next free extent 132. Was a free extent found 136. If yes, assume Z GB is the size of this extent 140 and go to step 118. If no, cannot create the vdisk and release previous allocated extents 138 wherein the expansion failed 142.

FIG. 10 is a block diagram illustrating an example of Local Unit number (LUN) mapping interface. This interface is shared by all vdisks on a storage enclosure to present a vdisk to a host at user specified LUN address. This user specified LUN address is called hLUN. The storage virtualization system may present one vdisk to multiple hosts at different or same hLUNs and also enforces that one host can only access a vdisk through an unique hLUN on that host. Each vdisk has an unique internal LUN address. This internal LUN address per vdisk is called iLUN. The LUN presentation function is to direct an IO request of <WWN, hLUN> to a corresponding vdisk of iLUN. <WWN, hLUN> represents an IO request from a host with WWN to this host perceived LUN address of hLUN. There are two tables to facilitate the LUN presentation, also known as LUN mapping. This first table is called LMAP T1 144, and the second table is called LMAP T2 146, as shown in figure x. The LMAP T1 144 table stores user specified LUN mapping parameters, i.e., the content of LMAP T1 144 is from user input. The LMAP T2 146 is deduced from LMAP T1 144. As LUN mapping translation occurs for every I/O request, a hash function is used for quick lookup on LMAP T1 144 and LMAP T2 146. The hash key for LMAP T1 144 is <wwn, hlun>, so is <wwn, ilun> for LMAP T2 146.

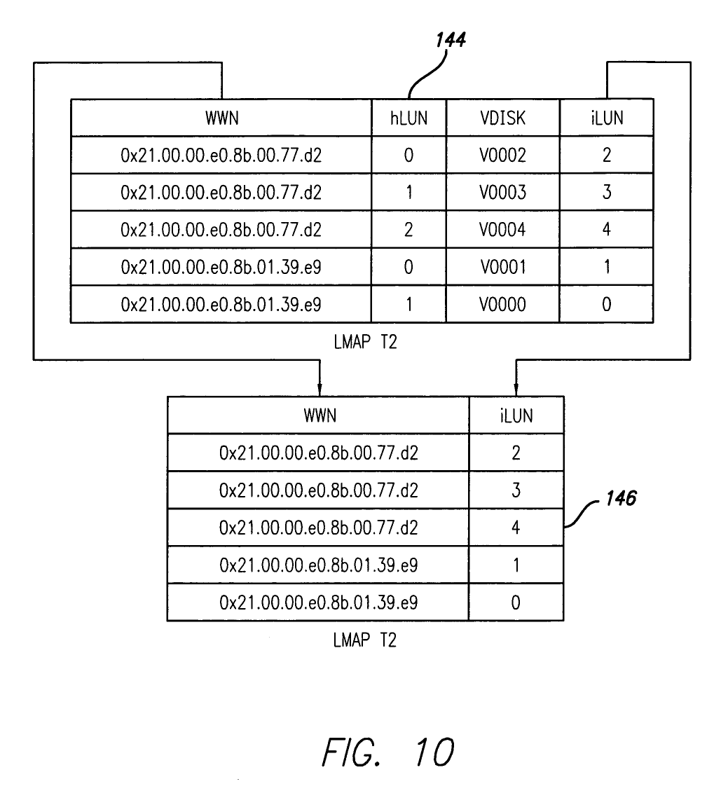

FIG. 11 is a flowchart for a procedure of LUN masking (access control). This interface enforces the LUN access control to allow on specified hosts to access a vdisk. A host is represented by the WWNs of its fibre channel adapters. The vnode interface can store up to 64 WWNs to support access control up to 64 hosts. The access control can be turned on and off per vdisk. If a vdisk's control is off, any host can access the vdisk. Referring to FIG. 11 the I/O request to vdisk X from host Y of WWNi 148. Check the X's access control 150. If the X's access control is not on then grant access 152. If the X's access control is on then check 156 if WWNi is in X's WWN table and if it is grant access 158 and if not deny access 154.

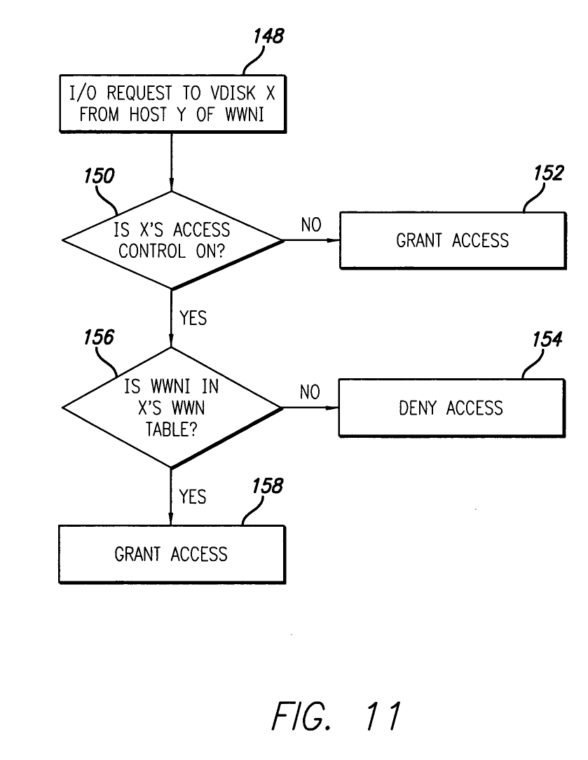

FIG. 12 is a schematic illustration of Logical Unit (LUN) number mapping and masking. The LUN Access Control Interface 161 controls which hosts 162 and 164 for example may access the which volumes 160. The host is represented by the WWNs of its fibre channel adapters. Access control can be turned on and off per volume. If access control is turned off, all hosts can access the volume 160. Referring to FIG. 13 there is shown a table 166 depicting operating system (OS) partition and file system interface. The storage virtualization system can detect if OS partitions 168 exist on a vdisk by scanning the front area of the vdisk. If OS partitions 168 are detected, it will scan each partition to collect file system information 170 on a partition. The collected partition and file system information is stored in the vnode's file system interface as depicted in table 166. Up to eight partitions per vdisk may be supported. A warning threshold 180 is provided which is a user specified percentage of file system used space over its total capacity 176. Once the threshold 180 is exceeded, the storage virtualization system will notify the user to grow the vdisk and file system capacity. Date services can operate on a specific partition by using the partition start address 172 and partition length 174.

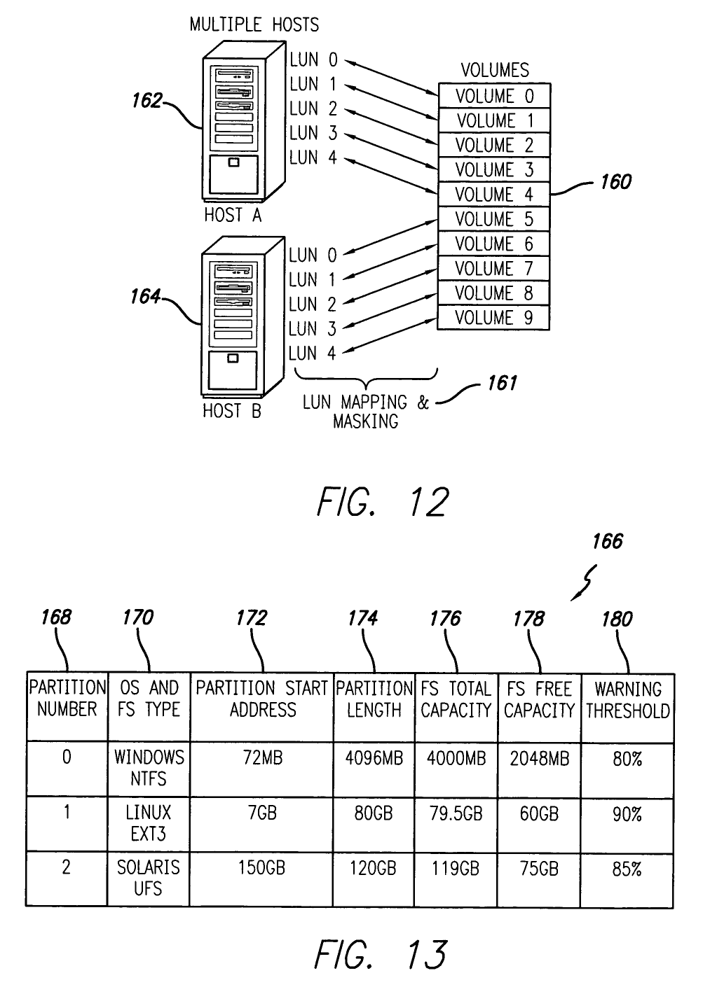

Referring now to FIG. 14 there is shown a flowchart for a procedure of storage allocation when growing a virtual disk. First, a Host request access (Read/Write) is received with X blocks starting at block number Y on a vdisk 182. Then find on which extent(s) the stripe <Y . . . Y+X−1> resides by lookup on the extent table 184 and find any extent 186. If no extent is found then the translation failed and access is denied 188. If extents are found then find only one 190 wherein this stripe wholly resides in one extent, say it's Ei 192. Then set Yp=Y+Ei_pool start address wherein Yp: Ei's start address on the pool 196 and access the physical stripe on the pool as <Yp . . . Yp+X−1> 198. The translation is now done 204. If more than one extent is found 190 then this stripe overrides two extents, say they are Ei and Ej and assume X1 blocks resides in E1, X2 blocks in Ej, X=X1+X 194. Then set Yp=Y+Ei_pool_start address and Yq=Ej_pool_start address wherein Yp: Ei's start address on the pool and Yq: Ej's start address on the pool 200. Next, access the physical stripes on the pool as <Yp . . . Yp+X1−1> and <Yq . . . Yq+x2−1> 202 and the translation is done.

As described above SAN servers share the virtualized storage pool that is presented by storage virtualization. Data is not restricted to a certain hard disk—it can reside in any virtual drive. Through the SANfs software, an IT administrator can easily and efficiently allocate the right amount of storage to each server (LUN masking) based on the needs of users and applications. The virtualization system may also present a virtual disk that is mapped to a host LUN or a server (LUN mapping). Virtualization system storage allocation is a flexible, intelligent, and non-disruptive storage provisioning process. Under the control of storage virtualization, storage resources are consolidated, optimized and used to their fullest extent versus traditional non-SAN environments which only utilize about half of their available storage capacity. Consolidation of storage resources also results in reduced costs in overhead, allowing effective data storage management with less manpower.

Addressing business continuity requirements for off-site files and migrating critical data between multiple storage arrays are two common problems small and mid-size IT operations must resolve in a cost effective manner. The remote replication services (RRS) provided and described enables serverless automated facilities to easily accomplish these tasks. Storage administrators may easily manage data movement and synchronization between local and remote storage volumes at 2 Gb/second Fibre Channel speeds:
produce remote mirrored copies of virtual volumes on another storage platform.
produce remote mirrored copies of virtual volumes on 3rd party Fibre Channel arrays.
acquire and migrate data from external Fibre Channel volumes and produce a virtual volume mirror.

When a company's business continuity requirements dictate the need to be able to restart a mission critical application immediately after a primary site disaster, remote synchronized copies of data are required. Therefore specified virtual volumes may be synchronously mirrored via 2 Gb/sec redundant Fibre Channel connections to remote locations. Any industry standard Fibre Channel LUN is an acceptable target that guarantees significant flexibility at the remote location, including third party storage. The flexibility to move data between storage arrays solves a variety of common problems storage administrators regularly face. One such task is movement of data from an older storage technology that is being displaced. The remote replication software solves the problem by reading data, without server involvement, from any industry standard Fibre Channel LUN and producing an exact copy on a specified virtual volume. When the copy is complete, the newly created virtual volume can be assigned to an attached application server for immediate use.

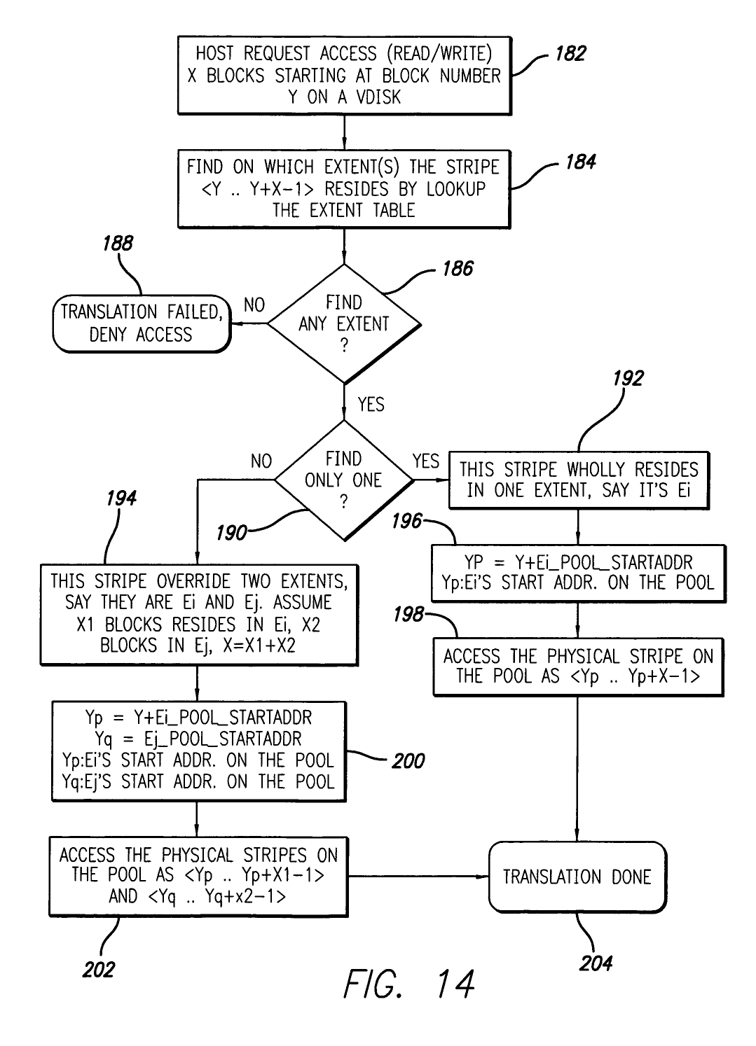

Referring to FIG. 15 there is shown a schematic illustration of a remote replication system 208. A remote replication system 208 for reads data, without server 32 involvement, from any industry standard Fibre Channel 30 LUN and producing an exact copy on a specified virtual volume is provided. The remote replication system 208 further produces remote mirrored copies of virtual volumes on another storage platform 206 and remote mirrored copies of virtual volumes on 3rd party Fibre Channel arrays. Additionally, the remote replication system acquires and migrates data from external Fibre Channel volumes, producing a virtual volume mirror and n-way copies.

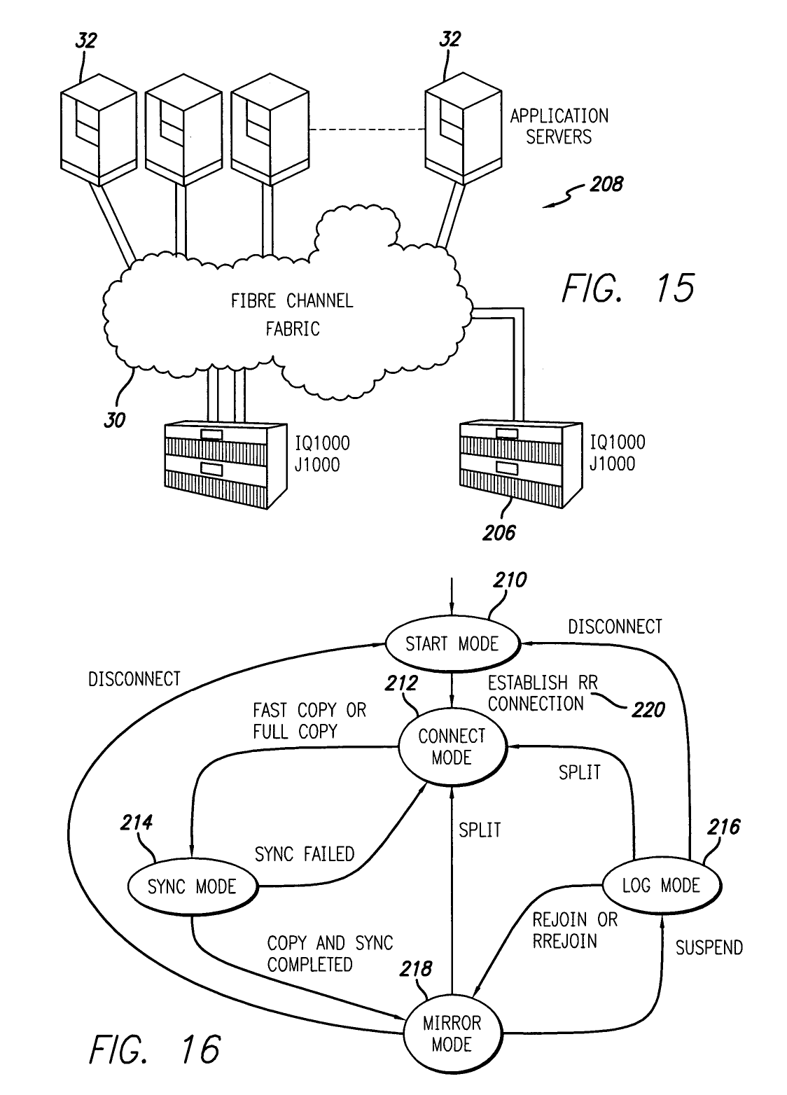

FIG. 16 is a flowchart for a procedure of remote replication. For purposes of explaining the remote replication process the source disk/volume at replication source site will be referred to as Sdisk and the replication disk/volume at the replication remote site will be referred to as Rdisk. Referring now to the flowchart in FIG. 16, in the start mode 210 a remote replication case has been planed out as follows: 1) Sdisk and Rdisk(s) have been chosen, 2) outbound ports and inbound ports have been selected, 3) access control between Sdisk and Rdisk(s) has been setup. But no connection has been established between Sdisk and Rdisk(s). A Start Mode can only transit to the Connect Mode 212. Next, a remote replication connection has been established 220 between Sdisk and Rdisk but the data content relationship is unknown. The Connect Mode may only transit to Sync Mode 214 wherein the Sdisk and Rdisk are undergoing data exchange to have the same data content on both disks. The write to Sdisk or Rdisk is logged in its scoreboard. The Sync Mode 214 is a volatile mode which will automatically transit to Mirror Mode 218 if successfull or the Connect Mode 212 if failed. In the Mirror Mode 218 the Sdisk and Rdisk have the same data content, and any write to Sdisk is replicated to Rdisk. The Mirror Mode can transit to Log Mode 216 or Connect Mode 212 or Start Mode 210. The Log Mode 216 writes to Sdisk or Rdisk which are logged in its scoreboard, and is not replicated to its peer. Log Mode 216 can transit to the Mirror 218 Mode or Connect Mode 212 or Start Mode 210.

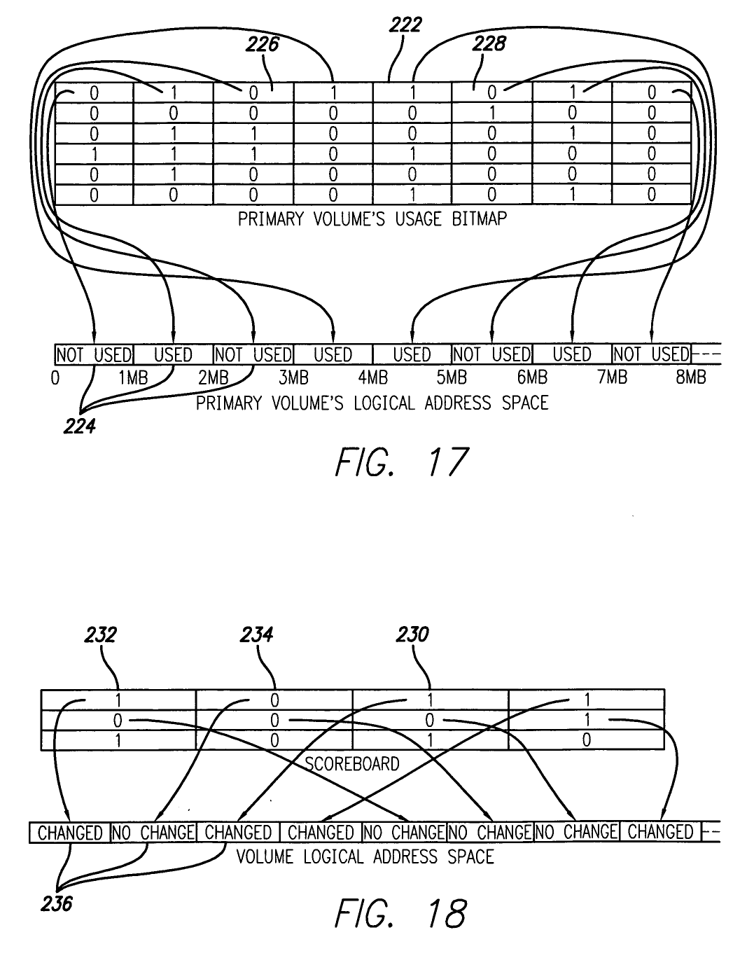

Referring now to FIG. 17, there is shown a graphical representation of the bitmap usage layout in matrix form for remote replication. Volume usage bitmap is utilized to achieve fast synchronization (i.e., bringing the destination to be the same as the primary's volume usage bitmap 222). Volume usage bitmap is stored with the primary volume to record written spots. Referring to FIG. 17, one (1) bit 226 represents 1 MB 224 wherein one (1) bit indicates the corresponding location has been written and bit zero (0) 228 indicates the corresponding location hasn't been written, i.e., no valid data in the location. When copying the primary volume 222 to the destination, only those “used chunks” indicated by its bitmap (1 MB per chunk) need to be copied instead of copying the whole volume. This technique is especially useful when primary volume size is huge but only portion of it is ever used. By only copying the “used chunks”, the second/destination volumes may achieve the mirror state quickly.

Turning now to FIG. 18 there is shown a graphical representation of the scoreboard usage layout in tabular form for remote replication. Scoreboard 230 is created to record changes when the remote replication is in logging mode. The primary volume and its replication volumes have their own scoreboards. Scoreboard 230 is stored with its associated volume as remote replication metadata such that the scoreboard is persistent between systems reboots. When remote replication is transmitted to mirror mode, scoreboard resources will be released. Referring once again to FIG. 18, each bit in a scoreboard represents a 256 KB data chunk 236 where bit one (1) 232 indicates the corresponding chunk has been changed during the logging mode and bit zero (0) 234 indicates the chunk hasn't been changed. When syncing destination volume to be the same as primary volume, or vice versa, only those data chunks recorded by the scoreboard need to be copied. The scoreboard may be used on both directions (primary to secondary sync., or secondary to primary sync.).

For companies seeking a robust and scalable long distance solution for business continuity, disaster recovery and data protection applications, asynchronous remote replicationdata services addresses the business continuity requirements of SMBs and SMEs, enabling companies to easily replicate data to secondary sites in a cost-effective and highly efficient manner. Using remote replication, companies may easily extend their storage infrastructures via iSCSI to setup secondary remote storage locations anywhere in the world, without distance limitations. Activating the remote replications data services available allows the quick and efficient transfer of data to off-site locations, whether the location is around the corner, across the country or around the globe. The remote replication described above provides an extremely cost-effective and flexible solution for synchronizing business data between local and long distance remote volumes via IP, allowing immediate use of remote volumes when needed. Additionally, the remote replication service simplifies moving and using data over extremely long distances from external sources, making the entire process straightforward, efficient and affordable and enabling companies to restart mission-critical applications immediately after a primary site disaster, bringing critical activities back online.

What is claimed is:

1. A remote replication system, comprising:
reading data, without server involvement, from any industry standard Fibre Channel LUN and producing an exact copy on a specified virtual volume.

2. The remote replication system according to claim 1 further produce remote mirrored copies of virtual volumes on another storage platform.

3. The remote replication system according to claim 1 for producing remote mirrored copies of virtual volumes on 3rd party Fibre Channel arrays.

4. The remote replication system according to claim 1 for acquiring and migrating data from external Fibre Channel volumes and producing a virtual volume mirror.

5. The remote replication system according to claim 1 for producing n-way copies.

6. A remote replication system, comprising:
means for reading data, without server involvement, from any industry standard Fibre Channel LUN; and
means for producing an exact copy on a specified virtual volume.

7. The remote replication system according to claim 6 further comprising:
means for producing remote mirrored copies of virtual volumes on another storage platform.

8. The remote replication system according to claim 6 further comprising:
means for producing remote mirrored copies of virtual volumes on 3rd party Fibre Channel arrays.

9. The remote replication system according to claim 6 further comprising:
means for acquiring and migrating data from external Fibre Channel volumes and producing a virtual volume mirror.

10. The remote replication system according to claim 6 further comprising:
means for producing n-way copies.

11. A remote replication system, comprising:
reading data, without server involvement, from any industry standard Fibre Channel LUN and producing an exact copy on a specified virtual volume producing n-way copies.

12. The remote replication system according to claim 1 further produce remote mirrored copies of virtual volumes on another storage platform.

13. The remote replication system according to claim 1 for producing remote mirrored copies of virtual volumes on 3rd party Fibre Channel arrays.

14. The remote replication system according to claim 1 for acquiring and migrating data from external Fibre Channel volumes and producing a virtual volume mirror.
